(19) United States
(12) Patent Application Publication
(10) Pub. No.: US 2024/0026697 A1
(43) Pub. Date: Jan. 25, 2024

(54) Compaction System with Determination of Compaction Progress

(71) Applicant: Wacker Neuson Produktion GmbH & Co. KG, Reichertshofen (DE)

(72) Inventors: Christian Lange, Ingolstadt (DE); Rudolf Berger, Gruenwald (DE); Patrick Diller, Hohenwart (DE); Dirk Sibila, Moorenweis (DE); Markus Martin, Raisting (DE); Alto Weiskopf, Altomuenster (DE)

(21) Appl. No.: 18/225,383

(22) Filed: Jul. 24, 2023

(30) Foreign Application Priority Data
Jul. 25, 2022 (DE) 10 2022 118 541.9

(51) Int. Cl. E04G 21/08; B01F 31/00; B01F 35/32; B01F 33/501; B01F 35/22; B28C 5/48; H02K 11/20; H02K 7/14

(52) U.S. Cl. CPC E04G 21/08; B01F 31/70; B01F 35/3204; B01F 33/5011; B01F 35/2202; B28C 5/485; H02K 11/20; H02K 7/14; B01F 2101/28

(57) ABSTRACT

A compaction system has a compaction device with an electric motor for generating a compaction movement, an energy device for providing electric energy for the electric motor, a measurement device for measuring the current drawn by the electric motor, and an evaluation device for evaluating the current draw as measured by the measurement device and for determining, from this determination, the compaction progress in the medium being compacted. The evaluation device is arranged at least partly in an external device, spatially separate from the energy device and/or from the compaction device.

### BACKGROUND OF THE INVENTION

### 1. Field of the Invention

The invention relates to a compaction system for the compaction of a medium, by way of which it is possible to determine the compaction progress during the compaction process, among other things.

### 2. Description of the Related Art

Such a compaction system is especially suitable in one embodiment as a concrete compaction system for compaction of still flowable concrete, such as an internal vibration device (internal vibrator). In another embodiment, the compaction system can be designed as a ground compaction system, e.g., having a vibration or shaker plate or a pounder for ground compaction.

Concrete compaction systems, in particular so-called internal vibrators, are known. They have an unbalance exciter arranged in a so-called vibrator head (vibrator housing), which is immersed in the still flowable concrete to be compacted in order to compact it by introducing vibrations.

The unbalance exciter is usually driven in rotation by an electric motor which is also arranged in the vibrator head. For this purpose, the electric motor must be supplied with a suitable current, in particular with a suitable voltage and a suitable frequency. For this purpose, a frequency converter is connected upstream, which converts the current supplied in a suitable manner. The electrical power supply can be provided via the public power grid or alternatively the power network available at a construction site.

In the more recent past, however, rechargeable battery technology has developed to such an extent that the electrical power supply can also be provided by way of an electrical energy storage device (rechargeable battery).

DE 10 2018 118 552 A1 discloses a supporting device with energy storage device and electrical converter. The supporting device can be designed in the form of a backpack and comprise a rechargeable battery and a converter, in order, for example, to supply an internal vibrator with suitable electrical current.

The internal vibrator itself comprises an operating hose, on which the vibrator head is fastened and which can be held by the operator in order to immerse the vibrator head in the concrete to be compacted. The electrical supply lines to the electric motor in the vibrator head also run inside the operating hose. Accordingly, the operating hose also serves as a protective tubing. At the transition between the end of the operating hose and the connecting cable leading to the frequency converter, there is a switch with which the operator can activate and deactivate the internal vibrator.

The rechargeable battery system worn e.g. as a backpack can be used for a plurality of devices, including a wearable frequency converter for the operation of an internal vibrator. The rechargeable battery system in this case can communicate with the frequency converter.

A device for recording the location and the duration of a compaction process for an internal vibrator is known from EP 2 574 916 A2. It is possible to judge the compaction results with the aid of the “switched on” time of the internal vibrator. However, the “switched on” time only allows conclusions as to the quality of the compaction. There is no distinguishing among different operating states or consideration of the actual compaction, so that the quality of the compaction can ultimately be determined only in a very imprecise manner. Furthermore, additional measurement systems are required.

### SUMMARY OF THE INVENTION

The invention is based on the task of specifying a compaction system for the compaction of a medium making it possible to recognize a particular operating state and judge the compaction process. A minimum of additional hardware components should be necessary for this, so that basically one can make use of existing hardware. In particular, the use of additional measurement systems should be avoided.

The task is solved according to the invention by a compaction system having a compaction device with an electric motor that is configured to generate a compaction movement; an energy device that is configured to provide electric energy for the electric motor; a measurement device that is configured to measure the current drawn by the electric motor; and an evaluation device. The evaluation device is configured to evaluate the current draw as measured by the measurement device and to determine, from this evaluation, the compaction progress in the medium being compacted. The the evaluation device is arranged at least partly in an external device, spatially separate from the energy device and/or the compaction device.

The medium to be compacted can be concrete or ground, so that depending on the application one can speak of a concrete or a ground compaction.

Accordingly, the compaction device can comprise an unbalance exciter, e.g., one with one or more unbalance shafts, which are placed in rotation by the electric motor. As a result of this, strong vibration forces are produced, which can be introduced in suitable manner into the medium being compacted.

In the case of a concrete compaction, the electric motor and the unbalance exciter can be arranged in a vibrator housing, a so-called vibrating head, which is suspended with the aid of a protective and operating hose in the concrete being compacted. The vibrations of the unbalance exciter are transmitted via the vibrating head to the concrete for its compaction.

In a ground compaction device, the unbalance exciter can comprise one or also often two (or more) unbalance shafts. The resulting vibration forces are introduced via a ground contact plate into the ground being compacted.

The energy device can comprise a battery (rechargeable battery) or also provide a grid connection, for connecting the electric motor to the public power grid.

The measurement device can be configured in particular to measure electric current, but also electric voltage or electric power. In this way, the electric power drawn by the electric motor can be detected as the central measurement criterion, allowing conclusions to be drawn as to the compaction process and especially the compaction progress.

During the operation of the electric motor, the measurement can be taken at a suitable sampling rate of, e.g., less than 5 s, especially less than 2 s, less than 1 s, less than 0.5 s or also less than 1/10 s.

The evaluation device can draw conclusions as to the compaction and thus the compaction progress in the medium being compacted based on the current draw as measured by the measurement device. In particular, the evaluation device can place the detected current measurement values and current measurement value curves in relation to previously known criteria and profiles and draw conclusions from this. This is also possible by evaluating the change in the current gradient of the current consumption over time.

The evaluation device is arranged at least partly in an external device, which is spatially separate from the energy device and/or the compaction device. The external device can be a mobile device, which is provided spatially separate from the energy device and the compaction device. In particular, the external device can be a mobile radio device, a smartphone, a tablet, a computer (also a portable computer). Likewise, a data transmission in the Internet is possible for a cloud application. For example, the evaluation device may comprise a solution based on artificial intelligence, which is provided on external hardware, e.g., also in a cloud. In this way, computing capacity can be provided with the aid of the external device, by which the evaluation device can determine very precisely and very efficiently the operating state and the compaction progress. Thanks to the provision of computing capacity by way of the external device, it is not necessary to provide the computing capacity directly on the compaction device or the energy device. Instead, these devices can basically be constructed in the traditional manner.

The energy device may comprise a battery (especially a rechargeable battery), and the battery may have battery control electronics, forming one unit spatially with the battery, and the measurement device being at least partly integrated in the battery control electronics. The battery control electronics usually constitutes a battery management system which is provided for monitoring the battery in order to ensure an effective and secure charging of the battery, but also to control and regulate a gentle discharging of the battery.

The battery control electronics generally has a measurement device for detecting the current drawn from the battery. This measurement device constitutes part of the compaction system according to the invention. Thus, no additional measurement device is required, since the measurement device is already provided by the battery which is present anyway.

The energy device can furthermore comprise a converter, for converting a current drawn from the energy device into a current suitable for the electric motor, wherein the converter comprises converter control electronics, forming a unit spatially with the converter, and wherein the measurement device is integrated at least partly in the converter control electronics. The converter can be in particular a frequency converter, in order to supply the electric motor with suitable current and suitable voltage. The converter control electronics can also be designed to provide for its part the measurement device according to the invention and thus detect the current draw by the electric motor precisely and with a high sampling rate. Optionally, the measurement device can also be distributed between the control electronics of the battery and the converter or alternatively be formed together by them.

Depending on the configuration, the energy device can also comprise a unit having a battery and a converter, which are actuated by common control electronics.

The evaluation device can be configured to determine an operating state of the compaction device based on the electric current presently detected by the measurement device.

The compaction device can be designed as a concrete compaction device, comprising a vibrator housing for immersion in flowable concrete; an unbalance exciter driven by an electric motor that is arranged in the vibrator housing; a current detection device acting as a measurement device for detecting the electric current absorbed by the electric motor; and comprising an evaluation device for determining an operating state of the concrete compaction device based on the electric current that is currently detected; wherein the operating state is selected from the group consisting of: “positioning of the vibrator housing in the air” (“operation of the electric motor at no load”), “immersion of the vibrator housing in the concrete,” “performance of a compaction process with the vibrator housing immersed in the concrete,” “emersion of the vibrator housing from the concrete”; and wherein the evaluation device is configured to recognize all said operating states.

The operating states can, in particular, thereby be recognized on the basis of the respective precisely detected current flow with a correspondingly high sampling rate. In this, it is not only the current value, but rather also the change in the current values over time (for example, detectable with the help of the sampling rate) that plays a role, so that specific current profiles can be detected and recognized. Based on the tendency of the current flow, the evaluation device can recognize the different operating states and—if useful—also distinguish them one from each other. For this purpose, the respectively detected current profile, with current values and current flows or alternatively gradients can be compared, for example, with known values or alternatively patterns in order to draw conclusions therefrom about the respective operating state.

The operating states “positioning of the vibrator housing in the air” and “operation of the electric motor at no load” are to be regarded as identical. In this case, the vibrator housing is still in the air and is still not immersed in the concrete. The electric motor can be operated at no load or approximately at no load since the unbalance exciter can still rotate freely.

The compaction work begins with the operating state “immersion of the vibrator housing in the concrete”. The vibrator housing is successively immersed into the flowable concrete, which absorbs and damps the oscillations of the vibrator housing. During this process, the current draw of the electric motor is increased in order to be able to drive the unbalance exciter as before.

In the operating state “performance of a compaction process,” the vibrator housing is substantially fully immersed in the concrete and is held substantially stationary by the operator at one point such that the vibrator housing dwells in the concrete. Due to the compaction effects in the concrete, the damping effect of the concrete on the vibrator housing changes, which in turn takes the form of opposing forces or alternatively reaction torques acting on the unbalance exciter. This changes the current draw of the electric motor, which can be detected by the evaluation device.

In the operating state “emersion of the vibrator housing from the concrete,” the vibrator housing is emersed from the concrete and lifted. This results in the vibrator housing being able to vibrate in an increasingly free manner, since the damping effect of the concrete gradually decreases. Accordingly, the electric motor can also once again rotate freely, such that the power absorbed by it is reduced and power consumption is lowered.

The evaluation device can be used, with the help of the respectively sampled current values and the gradients of the current values or alternatively the tendency of the current value development, to respectively recognize the working state of the internal vibrator. During the compaction process (“performance of a compaction process”), the evaluation device can recognize the compaction state of the concrete on the basis of the current profile, which is to say the current values and the gradient development, and compare it, for example, with specific limit values. When a certain limit value is reached, this is taken as a criterion that the concrete has been sufficiently compacted at this point.

In one variant, the evaluation device can recognize the operating states “electric motor switched off” and “electric motor and/or unbalance exciter defective” as additional operating states. In this case, the electric motor either does not absorb any current, or a current draw or current profile is recognized that does not fit into the schemes for the normal operating states, for example, a current draw that is too low or too high.

The current detection device can be configured to detect, in addition to the current, also the electric voltage applied to the electric motor. This allows the measurement accuracy to be further increased.

The evaluation device can be configured to determine the respective operating state taking into account the respective currently detected current profile with a currently detected electric current and/or a respectively determinable current gradient. The current gradient is a change in the current value present over time. Depending on the absolute current value detected, possibly in conjunction with the current gradient, the evaluation device can thereby detect the operating state and also the degree of compaction in the concrete. In so doing, the current value and current gradient can be evaluated together or separately. An example of the evaluation will be elucidated later in the figure description.

An interpretation device can be provided for interpreting the current flow when the operating state “performance of a compaction process” is recognized, wherein the interpretation device can be configured to evaluate the respective current gradient for interpreting the current flow, and wherein an approach of the current gradient to the zero value is considered a criterion for compaction progress. An approach of the current gradient to the zero value means that the curve of the current flow becomes flatter. This can be observed over the course of the compaction process, wherein an approach of the current gradient to the zero value means that the current, then currently being absorbed, hardly changes at all. This is taken as a criterion that the concrete has been sufficiently compacted in the area of the vibrating head.

The evaluation device can be configured to recognize whether a prescribed compaction progress has been reached. Various criteria can be predefined for what compaction progress has been reached at which current profiles or curves and gradients.

An interpretation device can be provided for interpreting the current flow when the operating state “performance of a compaction process” is recognized, wherein the interpretation device can be configured to evaluate the respective current gradient for interpreting the current flow, and wherein an approach of the current gradient to the zero value is considered a criterion for compaction progress. An approach of the current gradient to the zero value means that the curve of the current flow becomes flatter. This can be observed over the course of the compaction process, wherein an approach of the current gradient to the zero value means that the current, then currently being absorbed, hardly changes at all. This is taken as a criterion that the concrete has been sufficiently compacted in the area of the vibrating head.

A limit value for the approach of the current gradient to the zero value can be specified, wherein a signal device can be provided to generate a signal for an operator upon the reaching of the limit value by the current gradient. Thus, it is not mandatorily required that the current gradient actually reaches the zero value. Rather, a convergence to the zero value and thereby a reaching of the limit value may be sufficient. The reaching of the limit value means that the concrete has been sufficiently compacted at the location. This condition can be determined by the interpretation device, which thereupon signals to the operator, by way of the signal device, that the concrete has been sufficiently compacted so that the operator can move the vibrator housing to another location in the concrete.

The evaluation of the measurement results recorded by the measurement device may require a not inconsiderable computational capacity that is not available at the measurement device, the energy storage device or the frequency converter. In contrast, smartphones, laptops or tablets are readily capable of providing sufficient computational capacity. The required computational capacities depend, in particular, on the calculation model on which the detection of the progress of the compaction is based. If one assumes that power draw patterns are to be evaluated over a certain period of time, a great deal of data may be generated, requiring a greater computational capacity. It is also conceivable that the evaluation device also uses, at least in part, an artificial intelligence-based system to draw conclusions about the degree of compaction based on the patterns in power use that occur during concrete compaction.

As explained above, it is therefore advantageous to move the evaluation device at least in part to the external device, e.g., a mobile device. The mobile device can be moved in particular independently of the energy storage device or of the converter.

A communication interface can be provided between the measurement device and the evaluation device for transmitting data back and/or forth between the measurement device and the evaluation device. The communication can thus be one-way or bidirectional. A radio link can be used for the data transmission of the communication interface, such as Bluetooth, WLAN or mobile communication.

If the measurement device is integrated in the energy device, the data transmission can be provided accordingly via the communication interface between the energy device and the evaluation device. The data relates in particular to the recognition of the compaction progress or are used for determining the compaction progress.

If the measurement device is provided in the energy device, the measurement device can send the data via the communication interface to the external device.

Depending on the arrangement of the measurement device and the evaluation device, communication between the battery and the external device or the converter and the external device is possible. If the measurement device is arranged on the converter, the data can furthermore be transmitted from the measurement device to the battery control electronics, which in turn constitute part of the communication interface and accordingly can serve as a gateway for the data transmission to the external device.

The external device can comprise a human/machine interface for displaying information to an operator and/or for requesting information from the operator. The human/machine interface can be configured, e.g., as an app and be installed on the external device. It is possible in this case for the measured data to be displayed in prepared form, e.g., the compaction progress, but also the concrete consistency or the type of compaction device used. Conversely, operator input is also possible, in order to set the parameters in the compaction system.

A signal device can be provided for generating a signal for the operator, wherein the signal device can be designed to generate the signal in dependence on a state of the process, and wherein the state of the process can be selected from the group: compaction goal achieved, compaction goal not yet achieved, compaction faulty, error message. The signal device can be activated by the evaluation device in order to transmit findings determined by the evaluation device in the form of signals or warning messages to the operator. For this, the signal device can generate, e.g., optical, acoustic, or mechanical (haptic) signals, which can be easily perceived by the operator during the operation of the compaction system. In this way, the operator can very easily be informed as to the progress of their work. This is especially valuable when the operator is informed that their compaction goal has been achieved. Until such is the case, they must continue with the compaction. But once they have reached the goal, they can perform the compaction in another place.

The signal device can be arranged, e.g., on the external device. But it is likewise possible to provide the signal device on the energy device or the compaction device.

A documentation device can be provided for recording of data generated by the measurement device and the evaluation device. A large quantity of data may accrue when performing a compaction process and this data needs to be recorded in a suitable manner by the documentation device. This may involve the pure (raw) measurement results. But it is likewise possible to record the data and conclusions determined by the evaluation device.

In particular, the number of compaction processes and an evaluation of the compaction processes can also be recorded. Furthermore, position data, especially for the compaction device, can be saved, when such are detected during the compaction process. This position data may be GPS data, for example.

The documentation can occur through or with the aid of the external device, e.g., on the external device itself or also by making use of an Internet connection provided by the external device. In the latter case, the data can then be saved directly on a cloud server. This allows, e.g., a central documentation of all compaction processes throughout a construction site.

An identification device can be provided for identifying the compaction device based on predefined profiles for the current flow. In particular, the compaction devices may be exchanged for example in a concrete compaction system and compaction devices can be coupled to different vibrating heads. With the aid of memorized profiles for the current flow (running in air, surge in current in the concrete), the identification device can recognize which type of vibrating head is currently attached. A separate user input is then required for this, as long as the particular internal vibrator is known to the system.

### BRIEF DESCRIPTION OF THE DRAWINGS

These and other advantages and features of the invention are explained in more detail below by way of examples with the aid of the figures. Wherein:

FIG. 1 shows a concrete compaction system serving as a compaction system according to the invention in schematic representation;

FIG. 2 shows a variant of the compaction system of FIG. 1; and

FIG. 3 shows an example of the change in current draw as a function of the different operating states of a concrete compaction device.

### DETAILED DESCRIPTION

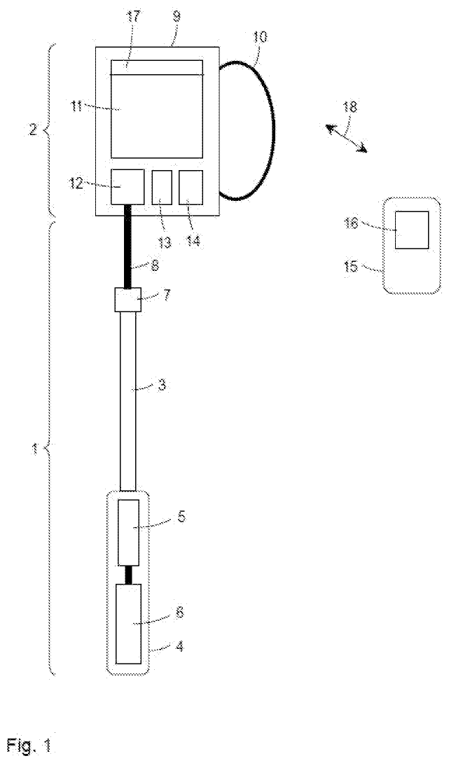

FIG. 1 shows a schematic representation of a concrete compaction system acting as a compaction system with an internal vibrator 1 and an energy device 2.

The internal vibrator 1 has an operating hose 3, at one end of which a vibrating head 4 serving as a housing is attached. Inside the vibrating head 4, an electric motor 5 is provided which drives an unbalance exciter 6 in rotation. The unbalance exciter 6 can be, for example, an unbalance shaft on which an unbalance mass is mounted eccentrically so that, when the unbalance shaft rotates, oscillations are generated which are introduced into the concrete to be compacted via the outer wall of the housing of the vibrating head 4. The construction of such a vibrating head 4 with electric motor 5 and unbalance exciter 6 is known in itself.

The operating hose 3 can comprise a length of several meters, so that the operator can also suspend the vibrator head 4, over a greater distance, in the concrete to be compacted during the compaction work. FIG. 1 is, moreover, not to scale and does not reflect the actual length of the operating hose 3.

A switching device 7 is attached to the end of the operating hose 3 opposite the vibrator head 4, via which switching device the electric motor 5 can be switched on and off. The switching device 7 can also serve as a connection point for a power line 8 (power cable). The electrical leads of the power line 8 are routed inside the operating hose 3 to the vibrator head 4, so that the operating hose 3 also takes on the function of a protective tubing.

At the end of the power line 8 opposite the switching device 7, a plug not shown in FIG. 1 may be provided in a manner known per se. The plug may be plugged into the power device 2.

In the example shown in FIG. 1, essential parts of the power device 2 are arranged on a supporting device 9, which can be carried by a user, for example, on their back, by way of carrying straps 10, in a manner similar to a backpack. In this, the supporting device 9 can comprise a carrying frame that reliably bears the components attached to it. This is also described, for example, in DE 10 2018 118 552 A1 and its U.S. counterpart US20200044206A1, the subject matter of each of which is incorporated herein in its entirety.

A rechargeable battery 11 is fastened to the supporting device 9 as an electrical energy storage device. The rechargeable battery 11 represents a central part of the energy device 2 and can be exchangeable and when exhausted, switched out with a fresh rechargeable battery 11.

Instead of the rechargeable battery 11, it is also possible to provide an electrical supply via the public power grid or a power network existing at the construction site.

Furthermore, the supporting device 9 bears a converter 12 which, in particular, converts the current drawn from the rechargeable battery 11, in terms of voltage and frequency, in a manner suitable for the electric motor 5. This converted current is then supplied by the converter 12 to the electric motor 5 via the power line 8.

Symbolically, a measurement device 13 and a vibration device 14 are also arranged on the supporting device 9. The measurement device 13 and the vibration device 14 do not need to be arranged as physically separate components on the supporting device 9. Rather, they can also be arranged in the rechargeable battery 11 or alternatively in the battery management system of the rechargeable battery 11 or also in the converter 12 or also elsewhere.

A mobile device 15, for example, a smart phone or a tablet, acting as an external device, is provided in spatially separated manner, in which mobile device an evaluation device 16 can be provided. The measurement device 13 and the evaluation device 16 together form a compaction recognition device. In particular, the evaluation device 16 may be installed as a program or alternatively as an app on the mobile device 15.

A transmitting and receiving device 17 is provided on the rechargeable battery 11 for coupling the mobile device 15 with the energy device 2. A data transmission 18 acting as a communication interface, to the mobile device 15 and in particular to the evaluation device 16 can be achieved with the aid of the transmitting and receiving device 17.

The measurement device 13 and the evaluation device 16 together form a compaction recognition device for recognizing progress of the compaction in the concrete. The measurement device 13 is thus able to monitor the consumption of current of the electric motor 5 during compaction operation. Since modern rechargeable battery systems often comprise a battery management system that very precisely documents the consumption of current, the measurement device 13 can accordingly also be integrated in the rechargeable battery 11 or use the battery management system there. The resulting data is transmitted via data transmission 18, for example, a radio link (Bluetooth), to the mobile device 15 and there to the evaluation device 16. The mobile device 15 provides sufficient computational capacity to allow the evaluation device 16 to perform the necessary calculations. By way of example, the evaluation device 16 can be installed as an app on the mobile device 15 and perform the calculations.

When the evaluation device 16 recognizes that the progress of the compaction is satisfactory and a prescribed degree of compaction has been achieved, the evaluation device 16 then sends a signal to the vibration device 14. The vibration device 14 is capable of generating a suitable haptic feedback signal that can be haptically perceived by the operator of the internal vibrator. The vibration device 14, likewise, need not be a physically separate component, but rather may be integrated into the other components, in particular, for example, into the converter 12 or alternatively into a control system of the converter 12 that is not shown. It serves only the functional task of generating the haptic feedback signal.

For this purpose, the signal from the evaluation device 16 about the achievement of the prescribed progress of the compaction can be received by the transmitting and receiving device 17 on the rechargeable battery 11 and forwarded to the converter 12, which then increases or reduces the rotational frequency of the electric motor 5. The increase or decrease of the rotational frequency can be done abruptly or continuously or combined with variable time intervals to inform the user about the progress of the compression. For example, it is possible to generate Morse code-like signals by changing the rotational frequency to inform the operator about the progress of the compression.

The change in engine rotational frequency leads to a change in the oscillation frequency of the internal vibrator 1. Since the operator guides the internal vibrator 1 on the operating hose 3 or on the switching device 7 by hand, the change in oscillation frequency is directly perceived as a vibration and can then be interpreted accordingly by the operator.

If the system recognizes that no further compaction is possible or useful at the current position of the internal vibrator 1 or of the vibrator head 4, a repeating pattern of fluctuating frequencies can be set to signal to the operator that the internal vibrator 1 should be used at a different position. The operator can thereinafter move the vibrator head 4 to an area of still uncompacted concrete using the operating hose 3.

In one variant, the vibration device 14 can, irrespective of a change in engine speed, also generate an independent oscillation similar to the vibrate alarm on a smartphone. For this purpose, the vibration device 14 can activate a small unbalance exciter (not shown), which is provided, for example, on the supporting device 9 or even on the switching device 7, so that the operator can feel the vibration with their back or their hands.

The mobile device 15 is not mandatorily necessary. It is likewise possible to also integrate the evaluation device 16 into the energy device 2, for example, into the battery management system of the rechargeable battery 11, if sufficient computational capacities are available there.

The rechargeable battery 11 can be configured in such a way that it can communicate with the connected converter 12 as well as with the mobile device 15. The necessary measuring devices can be integrated in the rechargeable battery 11 in order to sample the electrical power consumption with sufficient accuracy.

The communication between the rechargeable battery 11 or alternatively the transceiver 17 of the rechargeable battery 11 on the one hand and the mobile device 15 on the other hand is bidirectional by means of the data transmission 18 (communication interface), so that the results of the calculations or signals based thereon can be reported back from the external mobile device 15 to the rechargeable battery 11 or also to the converter 12 connected thereto.

As a result, the concrete compaction system is able to tangibly signal to the user that sufficient compaction has been achieved at the current position of the internal vibrator 1 or alternatively of the vibrator head 4. As a result, the compaction process can be carried out efficiently.

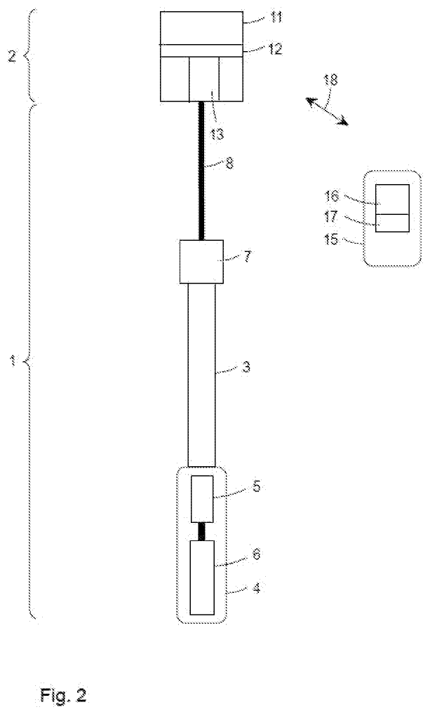

FIG. 2 shows in schematic representation another concrete compaction system, that is nonetheless similar to FIG. 1, having an internal vibrator 1 and an energy device 2. The same or similar features of the concrete compaction systems of FIGS. 1 and 2 are given the same reference numbers. There is no need to repeat the description of the same or similar components.

Symbolically, a current detection device 13, an evaluation device 16 and an interpretation device 17 are also provided in FIG. 2 on the energy device 2. These components can also be located elsewhere on the internal vibrator 1 or alternatively the concrete compaction device. However, their arrangement in the vicinity of the rechargeable battery 11 or alternatively of the converter 12 lends itself well in order to, there, precisely detect and interpret the current drawn by the electric motor 5.

The current detection device 13, the evaluation device 16. and the interpretation device 17 need not be physically separate components. Rather, they may also be arranged in the rechargeable battery 11 or in the battery management system of the rechargeable battery 11, or in the converter 12, or elsewhere. By way of example, the evaluation device 16 and the interpretation device 17 can also be spatially arranged elsewhere, for example, as a software application on a smartphone that is acting as mobile device 15 (for example a smartphone), carried by the operator of the internal vibrator. In this case, the communication link or alternatively communication interface in the form of the data transmission 18 must be provided to transmit the current values detected by the current detection device 13 to the evaluation device 16.

The current detection device 13 is used to detect the electric current absorbed by the electric motor 5. It is possible to detect the current in short sampling intervals, in order to obtain the most precise current profile possible.

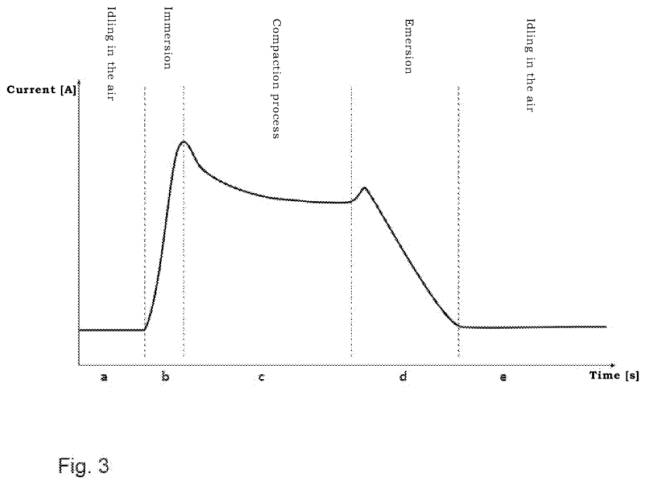

The measurement results of the current detection device 13 are passed on to the evaluation device 16, which can detect an operating state of the internal vibrator based on the then currently detected electric current (current values and current flow or alternatively current gradient), as explained below with reference to FIG. 3.

The interpretation device 17 is intended to interpret the current flow during a compaction process. In particular, the interpretation device 17 is intended to recognize and classify the compaction state during the compaction process.

When the interpretation device 17 determines that the concrete is currently sufficiently compacted, a signal device, not shown, can be used to signal the operator of the internal vibrator 1 to stop compaction at the corresponding location and continue compaction at another location.

Information relating to the state of compaction may be communicated to the operator in various ways. For example, the corresponding data can be displayed to the operator via assistance systems, for example, by applications installed on smartphones. In addition, logging of the measurement results for later documentation is also readily possible.

By way of example, FIG. 3 shows the flow of the current drawn by the electric motor 5 over time during various operating states of the internal vibrator 1. The respective current values can be detected by the current detection device 13 with short sampling intervals.

During phase a, the internal vibrator runs in the air and is not immersed in the concrete (idling phase, operation of the electric motor at no load, positioning of the vibrator housing in the air). In this phase, the absorbed current is constantly low.

During immersion of the vibrator housing in the concrete (phase b), the current draw increases and reaches a detectable maximum.

If the internal vibrator subsequently dwells in the concrete (compaction process), the concrete is compacted in the effective range of the vibrating head 4 (phase c). A partially decreasing current flow can be recognized, with a negative current gradient.

On the basis of the changing current gradients (current drop), the progress of the compaction process can be concluded by the evaluation device 16 in conjunction with the interpretation device 17. The further the compaction process progresses, the flatter the curve progression becomes, which is to say the current gradient approaches zero value. In this, the current absorbed always remains greater than in the idling phase in the air (phase a), so that the states of idling (phase a) and “immersed” or alternatively “compaction” (phase c) can always be clearly distinguished from one another.

When the vibrating head 4 emerses from the concrete (phase d), a brief increase in current can be observed due to the change in position of the vibrating head 4. Subsequently, the current absorbed falls back to the value corresponding to no-load operation as soon as the internal vibrator is in the air again. Finally, the current draw changes again to the no-load phase (phase e).

In particular, in the case of a portable energy device provided in a backpack system with an energy storage device that can be used to operate internal vibrators, measurement devices, for example, in the battery control electronics, are usually already present with which the input power can be measured in the form of current and voltage for operating the internal vibrators. Additional sensor technology, in particular, in the vibrating head or the protective tube, is not required.

Due to the high measurement accuracy and sampling rate, it is possible to infer from the current flow the operating state (no-load, immersion, dwell, emersion) and the compaction progress of the internal vibrator in the concrete. To determine the respective operating state, the measured values or alternatively their curves and changes are compared with known values or, alternatively, patterns.

The measurements can be carried out in a suitable manner for rechargeable battery-powered internal vibrators, but also for mains-powered internal vibrators.

The compaction system allows a multiplicity of combinations and working methods, which shall be explained in the following in order to add to and extend the previous remarks.

While the system formed by the rechargeable battery and the frequency converter (the connected internal vibrator is considered to be an actuator and can be switched on and off by the user) is active, the current flow and the input voltage are detected with a high sampling rate. The measurement equipment needed for this can be accommodated in the battery management system or alternatively in the frequency converter.

For the interpretation, the measured data can be sent by means of the communication interface in the rechargeable battery system to a further device (such as a smartphone, computer, smartwatch or the like) already present at the user, having the necessary computing power as well as a suitable application for the evaluation. Depending on the kind of evaluation, computing operations and/or operations of comparison with memorized profiles, especially current or current flow profiles, are possible.

In the case of power-grid-operated equipment, the measurement device and the communication interface can be integrated in the converter.

The external equipment (external device) can serve at the same time as an expanded human/machine interface for the displaying and requesting of information and boundary conditions needed for the determination of the compaction progress and for its documentation, such as the concrete consistency or the type of internal vibrator used.

The reaching of a suitable degree of compaction for the application can also be signaled through the external device, especially acoustically, optically, or by use of a vibration generator, if such is present in the device.

The user can also be informed if the last compaction process (beginning with the immersing of the internal vibrator and ending with the emersing) was inadequate or faulty, so that they can repeat this if necessary.

A documentation can be enabled for example by recording the number of compaction processes as well as evaluating which compaction processes were successful. Thanks to the use of the Internet connection of the external device, the compaction data can be transmitted to other devices or a corresponding cloud. This enables, in addition to the central documentation, also a simultaneous monitoring of the compaction processes and an ongoing adaptation.

Unlike the concept as described in EP 2 574 916 A2, the determination of the compaction quality is not carried out solely with the aid of the “switched-on” time of the internal vibrator, but instead by determining the compaction progress and the state of the equipment based on the interpretation of the current flow as well as with the data indicated by the user as to the internal vibrator being used and the concrete grade or alternatively concrete consistency.

The communication between the rechargeable battery and the external unit can be bidirectional, so that the results of the computations or signals based on them can be reported back from the external device to the rechargeable battery or also to the frequency converter connected to it.

In the case of compaction systems with power grid operation, i.e., without rechargeable battery, the measurement of the parameters can be done in the frequency converter, with a direct communication to the external device.

A measurement of the parameters in the frequency converter is also possible, in which case the data can be communicated via the rechargeable battery to the external device. In this case, the rechargeable battery plays the part of a gateway.

Artificial intelligence or machine learning can be used for the evaluation and interpretation of the current values or profiles when determining the compaction progress.

In one variant, an automatic identification of the type of vibrating head connected is possible with the aid of memorized profiles for the current flow (running in the air/surge in current in the concrete). In this case, no user input is needed, as long as the type of internal vibrator is known to the system.

Furthermore, in one variant the concrete grade can be recognized with the aid of the resulting current flow. Here as well, no user input is required.

The data can be evaluated and processed in an external network or a combination of networked systems or a cloud.

The interpretation and/or documentation of the compaction progress of ground compaction equipment (vibration plates, vibration pounder, vibration roller) is possible with the aid of the measured current flow.

In particular, the determination of the compaction progress and/or the state of compaction machines can be done with the aid of measured electric parameters and corresponding computing and comparison operations.

The determination of the compaction quality can be done by dependency simulation of representative measured quantities, especially with the aid of the current flow detected in the existing rechargeable battery system. The dependency of the current flow or alternatively the power absorbed by the internal vibrator in relation to the degree of compaction is influenced by multiple parameters. If all parameters are known (e.g., the characteristic curve of the internal vibrator being used), the present degree of compaction can be calculated or simulated based on the known and presently measured values.

According to the invention, measurement devices can be used which are installed in any case, e.g., for their own protection, in the corresponding devices (e.g., internal vibrators). In this way, it is possible to do without additional sensors in the vibrating head or in the protective hose.

A largely automated documentation of concrete compaction processes with internal vibrators is possible, without the use of costly additional hardware. The use of already present internal vibrators also becomes possible, since no retrofitting of sensors is required. The necessary computing operations can be performed on an external terminal device, such as a smartphone

The compaction system can constitute the basis for assistance systems which report to the user that sufficient compaction has been achieved at the present position of the internal vibrator. In this way, increased efficiency can be achieved in the compaction process and increased safety for load-bearing structures.

One essential idea is the use of computing power which the user generally also carries around, such as in the form of their smartphone. This eliminates further costs for the computing power which is needed in particular for the evaluation device and optionally the interpretation device. Resources can be saved.

1. A compaction system for the compaction of a medium, comprising:
a compaction device with an electric motor that is configured to generate a compaction movement;
an energy device that is configured to provide electric energy for the electric motor;
a measurement device that is configured to measure a current drawn by the electric motor; and
an evaluation device that is configured to evaluate the current draw as measured by the measurement device and to determine, from the evaluation, a compaction progress of the medium being compacted;
wherein
the evaluation device is arranged at least partly in an external device that is spatially separate from the energy device and/or from the compaction device.

2. The compaction system according to claim 1, wherein
the energy device comprises a battery;
the battery comprises a battery control electronics, forming one unit spatially with the battery; and
the measurement device is integrated at least partly in the battery control electronics.

3. The compaction system according to claim 1, wherein
the energy device comprises a converter that is configured to convert a current drawn from the energy device into a current suitable for the electric motor;
the converter comprises converter control electronics forming one unit spatially with the converter;
the measurement device is integrated at least partly in the converter control electronics.

4. The compaction system according to claim 1, wherein the evaluation device is configured to determine an operating state of the compaction device based on the respectively present electric current as detected by the measurement device.

5. The compaction system according to claim 1, wherein the evaluation device is configured to determine the respective operating state while considering the present electric current as detected by the measurement device and/or a respective current gradient determined from the detected electric current.

6. The compaction system according to a claim 1, wherein the evaluation device is configured to recognize whether a given compaction progress has been achieved.

7. The compaction system according to claim 1, wherein a communication interface is provided between the measurement device and the evaluation device, and wherein the communication interface is configured to transmit transmitting data to and/or back between the measurement device and the evaluation device.

8. The compaction system according to claim 1, wherein the external device comprises a human/machine interface that is configured to display ng information to an operator and/or to request information from the operator.

9. The compaction system according to claim 1, wherein
a signal device is provided that is configured to generate a signal for the operator;
the signal device is configured to generate the signal in dependence of a state of a process; and wherein
the state of the process is selected from the group consisting of:
that a compaction goal is achieved,
that a compaction goal is not yet achieved,
compaction is faulty,
an error message.

10. The compaction system according to claim 1, wherein a documentation device is provided that is configured to record data generated by the measurement device and the evaluation device.

11. The compaction system according to claim 1, wherein an identification device is provided that is configured to identify the compaction device based on predefined profiles for the current flow.
